(19) United States
(12) Patent Application Publication
(10) Pub. No.: US 2026/0014048 A1
(43) Pub. Date: Jan. 15, 2026

(54) CONNECTION STRUCTURE BETWEEN MASSAGE ATTACHMENT AND FASCIA GUN

(71) Applicant: Reestar International Limited, HONG KONG (HK)

(72) Inventors: Lihao XIA, Dongguan (CN); XianKui QIU, Dongguan (CN)

(21) Appl. No.: 19/209,638

(22) Filed: May 15, 2025

(30) Foreign Application Priority Data
Jul. 15, 2024 (CN) 202421663178.X

(51) Int. Cl. A61H 23/00; A61H 23/02

(52) U.S. Cl. CPC A61H 23/006; A61H 23/02; A61H 2201/0107

(57) ABSTRACT

An example connection structure between a massage attachment and a fascia gun is provided. The example connection structure may include a push rod assembly and a massage attachment. The push rod assembly may include a push rod sleeve, soft rubber for a connecting rod, and a connecting rod. A limiting member may be disposed at one end of the connecting rod. The massage attachment may include a cavity having a guide groove and a limiting groove. In some examples, the connecting rod may be inserted into the cavity to cause the limiting member to the guide groove. When the limiting member reaches an end of the guide groove, rotation of the massage attachment or push rod assembly may cause the limiting member to enter the limiting groove, securing the massage attachment to the push rod assembly.

### CROSS-REFERENCE TO RELATED APPLICATIONS

This patent application claims the benefit of and priority to Chinese Utility Patent Application No. 202421663178.X, filed with the Chinese Intellectual Property Office on Jul. 15, 2024, the contents of which are incorporated by reference in its entirety and for all purposes.

### TECHNICAL FIELD

The utility model relates to the field of massage equipment, in particular to a connection structure between a massage attachment and a fascia gun.

### BACKGROUND

A fascia gun is a massage tool used to assist in rehabilitation of soft tissue. The fascia gun uses its internal motor to drive a massage attachment to generate high-frequency vibrations that act on deep layers of human body's soft tissue, thereby reducing local soft tissue tension, relieving pain, and promoting blood circulation.

Depending on different massage parts, a fascia gun is usually equipped with multiple different massage attachments, so the massage attachments and the fascia gun body are usually set in a quick-detachable connection mode for easy replacement. A product currently on the market usually has an inner hole provided on a push rod of the fascia gun, and a soft rubber ring is provided outside a support rod of the massage attachment. Thus, when connecting the massage attachment to the fascia gun body, the support rod of the massage attachment is inserted into the inner hole on the push rod by hand, so that the soft rubber ring on the support rod forms an interference fit with the inner hole, thereby clamping the support rod in the inner hole to achieve a quick connection between the massage attachment and the fascia gun body.

When removing the massage attachment from the fascia gun body, the massage attachment can be directly and quickly pulled out by hand. Although this method can achieve quick connection and detachment between the massage attachment and the fascia gun body, when the support rod of the massage attachment is inserted into the inner hole of the push rod, an outer edge of the inner hole will scrape the soft rubber ring. After multiple installations, the soft rubber ring will be worn, which will cause insufficient interference fit between the soft rubber ring and the inner hole, resulting in unstable and insecure connection between the massage attachment and the fascia gun body, causing the massage attachment to wobble from side to side or even fall off during operation of the fascia gun. In addition, the massage attachment is often in direct contact with the skin, which is easy to get dirty and needs to be cleaned regularly. The soft rubber ring provided on the support rod of the massage attachment will also increase the difficulty of cleaning the massage attachment.

### SUMMARY

The objective of the utility model is to overcome the deficiencies of the prior art and to provide a connection structure between a massage attachment and a fascia gun, so that the massage attachment and the fascia gun body can be stably connected and quickly detached.

The technical solution of this utility model is: a connection structure between a massage attachment and a fascia gun, comprising a push rod assembly and a massage attachment, wherein the push rod assembly comprises a push rod sleeve, soft rubber for connecting rod and a connecting rod, the push rod sleeve, the soft rubber for connecting rod and the connecting rod are sequentially connected in a sleeving manner, the soft rubber for connecting rod sleeves the connecting rod, the push rod sleeve sleeves the soft rubber for connecting rod, a limiting member is provided on one end of the connecting rod, the massage attachment is provided with a cavity, on an inner wall of the cavity provided are a guide groove and a limiting groove that can match with the limiting member, when connecting the massage attachment to the push rod assembly, by inserting the push rod assembly into the cavity, the limiting member enters the guide groove, when the limiting member reaches the bottom of the guide groove, by rotating the massage attachment or the push rod assembly, the limiting member enters the limiting groove to lock the massage attachment and the push rod assembly in place.

Specifically, an annular protrusion is provided on the soft rubber for connecting rod, and when connecting the massage attachment to the push rod assembly, after the limiting member enters the guide groove, the annular protrusion is squeezed by the massage attachment and the push rod sleeve to undergo elastic deformation, and the elastic force generated by the clastic deformation leads to a tendency for the massage attachment and the push rod assembly to separate from each other, thereby causing the limiting member and the limiting groove to press against each other along an axial direction of the connecting rod to further lock the massage attachment and the push rod assembly in place.

Specifically, an annular flange is provided on a side of the annular protrusion close to the limiting member.

Specifically, the limiting groove comprises a recess and an elastic protrusion, the clastic protrusion is arranged on a side of the recess close to the guide groove, a side of the clastic protrusion close to the guide groove is an inclined surface, the limiting member comprises a first protrusion and a second protrusion that are spaced apart and arranged along an axial direction of the connecting rod, when connecting the massage attachment to the push rod assembly, after the limiting member reaches the bottom of the guide groove, by rotating the massage attachment or the push rod assembly, the first protrusion enters the recess, and the elastic protrusion is stuck between the first protrusion and the second protrusion to secure the massage attachment and the push rod assembly, or both the first protrusion and the second protrusion enter the recess, and the elastic protrusion blocks the first protrusion and the second protrusion in the recess to secure the massage attachment and the push rod assembly.

Specifically, the limiting member is a wedge-shaped protrusion, and the limiting groove is a wedge-shaped groove that can match with the wedge-shaped protrusion, when connecting the massage attachment to the push rod assembly, after the limiting member reaches the bottom of the guide groove, by rotating the massage attachment or the push rod assembly, the wedge-shaped protrusion and the wedge-shaped groove move toward each other, after the wedge-shaped protrusion and the wedge-shaped groove move toward each other to a certain position, an interference fit is formed between the wedge-shaped protrusion and the wedge-shaped groove, thereby locking the massage attachment and the push rod assembly in place.

Specifically, an elastic arm hook is provided at one end of the connecting rod away from the limiting member, and a groove which can match with the elastic arm hook is provided in an inner wall of the push rod sleeve.

Specifically, a plurality of convex rings are provided on an outer wall of the connecting rod on the side away from the limiting member.

Specifically, a DC power male terminal component is fixedly provided in an inner cavity of the connecting rod, and a DC power female terminal component is fixedly provided in the cavity of the massage attachment.

The utility model provides a connection structure between a massage attachment and a fascia gun, comprising a push rod assembly and a massage attachment with a cavity. When connecting the massage attachment to the fascia gun body, first, by inserting the push rod assembly into the cavity of the massage attachment, the limiting member reaches the bottom of the guide groove, and then by rotating the massage attachment or the push rod assembly, the limiting member enters the limiting groove to lock the massage attachment and the push rod assembly in place. In addition, the elastic force generated by the elastic deformation of the annular protrusion causes a tendency for the massage attachment and the push rod assembly to separate from each other, so that the limiting member and the limiting groove press against each other along the axial direction of the connecting rod to further lock the massage attachment and the push rod assembly in place. In this way, the massage attachment can be stably and securely connected to the fascia gun body. When operating the fascia gun, the massage attachment will not wobble from side to side or even fall off, the massage attachment and the fascia gun body can be quickly connected and detached, and the massage attachment is also easier to clean after removed.

### BRIEF DESCRIPTION OF THE DRAWINGS

In order to more clearly illustrate the technical solutions in the embodiments of the present utility model, the drawings needed in the embodiments will be briefly introduced below. Apparently, the drawings described below are only some embodiments of the present utility model. For ordinary technicians in this field, other drawings can also be obtained based on these drawings without creative work.

FIG. 1 is a cross-sectional view of a connection structure between a massage attachment and a fascia gun provided by an embodiment of the utility model.

FIG. 2 is a schematic structural diagram of the push rod assembly in the connection structure between a massage attachment and a fascia gun provided by an embodiment of the present utility model.

FIG. 3 is a schematic structural diagram of the massage attachment in the connection structure between a massage attachment and a fascia gun provided by an embodiment of the present utility model.

FIG. 4 is a schematic structural diagram of soft rubber for connecting rod in the connection structure between a massage attachment and a fascia gun provided by an embodiment of the present utility model.

### DETAILED DESCRIPTION

In order to make the objective, technical solutions and advantages of the present utility model more clear, the present utility model will be further described in detail below in conjunction with the accompanying drawings and embodiments. It should be understood that the specific embodiments described herein are only used to explain the present utility model and are not used to limit the present utility model.

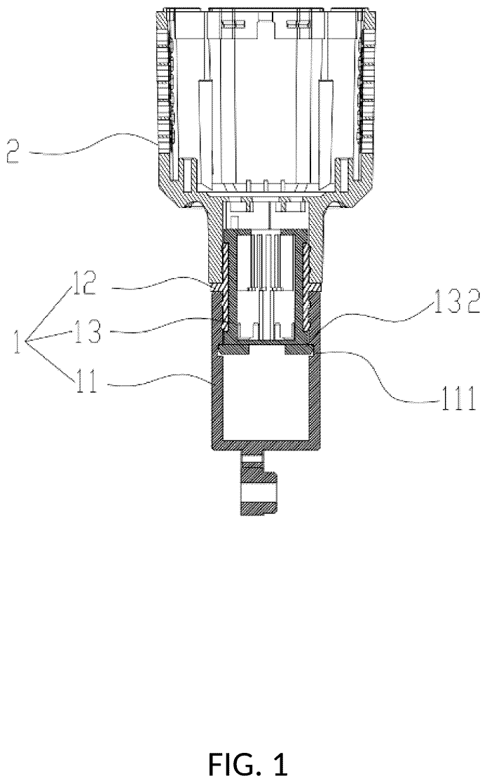

As shown in FIGS. 1-3, an embodiment of the present utility model provides a connection structure between a massage attachment and a fascia gun, including a push rod assembly 1 and a massage attachment 2. The push rod assembly 1 includes a push rod sleeve 11, soft rubber 12 for connecting rod, and a connecting rod 13. The push rod sleeve 11, the soft rubber 12 for connecting rod and the connecting rod 13 are sequentially connected in a sleeving manner. The soft rubber 12 for connecting rod sleeves the connecting rod 13, and the push rod sleeve 11 sleeves the soft rubber 12 for connecting rod. A limiting member 131 is provided one end of the connecting rod 13, and the massage attachment 2 is provided with a cavity 21. On an inner wall of the cavity 21 provided are a guide groove 22 and a limiting groove 23 that can match with the limiting member 131. When connecting the massage attachment 2 to the push rod assembly 1, by inserting the push rod assembly 1 into the cavity 21, the limiting member 131 enters the guide groove 22. When the limiting member 131 reaches the bottom of the guide groove 22, by rotating the massage attachment 2 or the push rod assembly 1, the limiting member 131 enters the limiting groove 23 to lock the massage attachment 2 and the push rod assembly 1 in place. When detaching the massage attachment 2 and the push rod assembly 1, by rotating the massage attachment 2 or the push rod assembly 1 in the opposite direction, the limiting member 131 is withdrawn from the limiting groove 23 and enters the guide groove 22. Then, the push rod assembly 1 is pulled out of the cavity 2. In this way, quick connection and detachment between the massage attachment 2 and the push rod assembly I can be achieved, and the connection between the massage attachment 2 and the push rod assembly 1 can be made more secure and stable, and the massage attachment 2 can be made easier to clean.

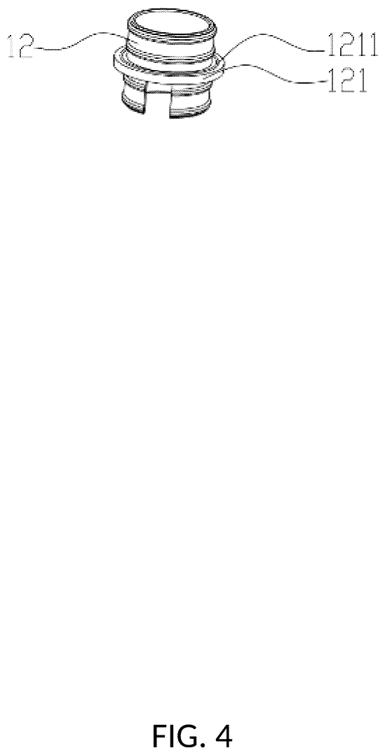

As shown in FIG. 4, specifically, an annular protrusion 121 is provided on the soft rubber 12 for connecting rod. When connecting the massage attachment 2 to the push rod assembly 1, after the limiting member 131 enters the guide groove 22, the annular protrusion 121 is squeezed by the massage attachment 2 and the push rod sleeve 11 to undergo elastic deformation. The elastic force generated by the elastic deformation leads to a tendency for the massage attachment 2 and the push rod assembly 11 to separate from each other, thereby causing the limiting member 131 and the limiting groove 23 to press against each other along an axial direction of the connecting rod 13 to further lock the massage attachment 2 and the push rod assembly 1 in place. This can make the connection between the massage attachment 2 and the push rod assembly 1 more stable and secure, and prevent the massage attachment 2 from wobbling from side to side or even falling off from the push rod assembly 1 during operation.

As shown in FIG. 4, specifically, an annular flange 1211 is provided on a side of the annular protrusion 121 close to the limiting member 131, so that when connecting the massage attachment 2 to the push rod assembly 1, the friction between the annular protrusion 121 and the massage attachment will not be too large, making it easier to rotate the massage attachment 2 or the push rod assembly 1.

As shown in FIGS. 1-3, specifically, the limiting groove 23 includes a recess 231 and an elastic protrusion 232, the elastic protrusion 232 is arranged on a side of the recess 231 close to the guide groove 22, and a side of the elastic protrusion 232 close to the guide groove 22 is an inclined surface. The limiting member 131 includes a first protrusion 1311 and a second protrusion 1312 that are spaced apart and arranged along an axial direction of the connecting rod 13. When connecting the massage attachment 2 to the push rod assembly 1, after the limiting member 131 reaches the bottom of the guide groove 22, by rotating the massage attachment 2 or the push rod assembly 1, the first protrusion 1311 enters the recess 231, and the elastic protrusion 232 is stuck between the first protrusion 1311 and the second protrusion 1312 to secure the massage attachment 2 and the push rod assembly 1, or both the first protrusion 1311 and the second protrusion 1312 enter the recess 231, and the elastic protrusion 232 blocks the first protrusion 1311 and the second protrusion 1312 in the recess 231 to lock the massage attachment and the push rod assembly in place, which can make the connection between the massage attachment 2 and the push rod assembly 1 more stable and secure, and can also achieve quick connection and detachment between the massage attachment 2 and the push rod assembly 1.

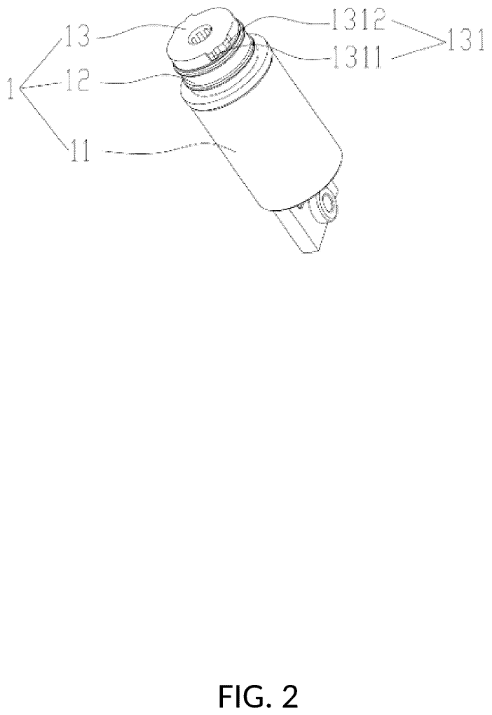

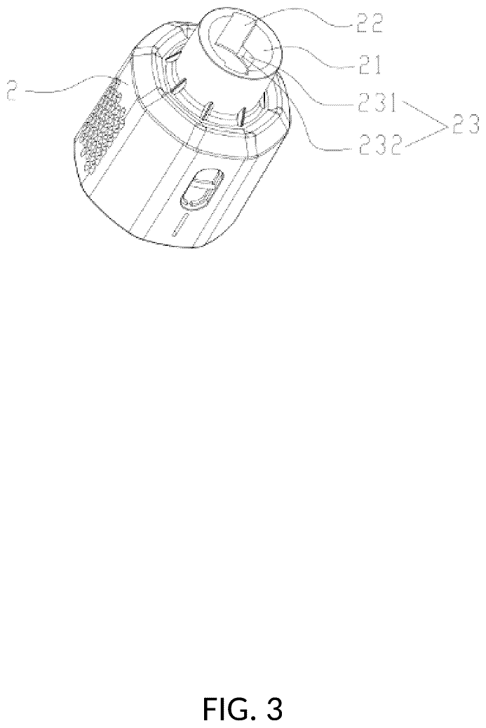

As described herein, the connecting rod 13 of the push rod assembly 1 may be configured with any number of limiting members 131 to facilitate engagement with the massage attachment 2. As illustrated in FIG. 2, the connecting rod 13 is shown as including two limiting member 131 that are spaced apart along an axial direction of the connecting rod 13. However, this configuration is merely exemplary. For example, the connecting rod 13 may include a single limiting member 131, or more than two limiting member 131 (e.g., three or more). The limiting members 131 may be equally spaced apart along the axial direction or arranged at unequal intervals, depending on design preferences or structural requirements. Moreover, the cavity 21 of the massage attachment 2 may also be configured with any number of guide grooves 22 and limiting grooves 23 that are positioned to match with or dimensioned to fit the number of limiting member 131 of the connecting rod 13. As illustrated in FIG. 3, the cavity 21 is shown including two guide groove 22 and two limiting groove 23 that are equally spaced apart along the axial direction of the cavity 21. However, this configuration is merely exemplary. For example, the cavity 21 may include a single guide groove 22 and limiting groove 23, or more than two guide groove 22 and limiting groove 23 (e.g., three or more each). The guide grooves 22 and limiting grooves 23 may also be equally or unequally spaced around the inner wall of the cavity 21, depending on design preferences or structural requirements. Such configurations provides greater flexibility for aligning the push rod assembly 1 with the massage attachment 2 and enhances compatibility with various structural configurations. Regardless of the specific quantity or spacing of the limiting members 131 and the corresponding guide grooves 22 and limiting grooves 23, the components may be configured to ensure a secure and stable engagement while still allowing for quick connection and detachment of the massage attachment 2 and the push rod assembly 1

In other embodiments, the limiting member 131 may also be a wedge-shaped protrusion (not shown), and the limiting groove 23 may be a wedge-shaped groove (not shown) that can match with the wedge-shaped protrusion (not shown). When connecting the massage attachment 2 to the push rod assembly 1, after the limiting member 131 reaches the bottom of the guide groove 22, by rotating the massage attachment 2 or the push rod assembly 1, the wedge-shaped protrusion (not shown) and the wedge-shaped groove (not shown) move toward each other. After the wedge-shaped protrusion (not shown) and the wedge-shaped groove (not shown) move toward each other to a certain position, an interference fit is formed between the two, thereby achieving locking of the massage attachment 2 and the push rod assembly 1 in place. In this way, the connection between the massage attachment 2 and the push rod assembly 1 can be made more stable and secure, and quick connection and detachment of the massage attachment 2 and the push rod assembly I can also be achieved.

As shown in FIG. 1, specifically, an elastic arm hook 132 is provided at one end of the connecting rod 13 away from the limiting member 131, and a groove 111 that can match with the elastic arm hook 132 is provided in an inner wall of the push rod sleeve 11. By inserting the elastic arm hook 132 into the groove 111, the connection between the connecting rod 13 and the push rod sleeve 11 can be made more stable and secure.

Specifically, a plurality of convex rings (not shown) are provided on an outer wall of the connecting rod 13 on the side away from the limiting member 131, and the convex rings are in interference fit with the inner wall of the push rod sleeve 11, so that the sleeve connection between the connecting rod 13 and the push rod sleeve 11 can be more stable and secure.

Specifically, a DC power male terminal component (not shown) is fixedly provided in an inner cavity of the connecting rod 13, and a DC power female terminal component (not shown) is fixedly provided in the cavity 21 of the massage attachment 2. In this way, when connecting the fascia gun body to the massage attachment 2 through the push rod assembly 1, the massage gun body can supply power to the massage attachment 2 through the DC power male terminal component and the DC power female terminal component.

In some examples, massage attachment 2 may include of limiting member 131, while push rod assembly 1 may include guide groove 22 and limiting groove. The push rod assembly 1 may include a push rod sleeve 11, soft rubber 12 for connecting rod, and/or a connecting rod 13. The push rod sleeve 11, the soft rubber 12 for connecting rod, and/or the connecting rod 13 are sequentially connected in a sleeving manner. The soft rubber 12 for connecting rod may sleeve the connecting rod 13, and the push rod sleeve 11 may sleeve the soft rubber 12 for connecting rod. The massage attachment 2 may be provided with a cavity 21. A limiting member 131 may be provided on an inner wall of the cavity 21. Connecting rod 13 of the push rod assembly I may be provided, on its surface, with a guide groove 22 and a limiting groove 23 that can match with or dimensioned to fit the limiting member 131. When connecting the massage attachment 2 to the push rod assembly 1, the connecting rod 13 may be inserted into the cavity 21 such that the limiting member 131 enters the guide groove 22. When the limiting member 131 reaches the bottom/top of the guide groove 22, the massage attachment 2 or the push rod assembly I may be rotated so that the limiting member 131 enters the limiting groove 23, thereby locking the massage attachment 2 and the push rod assembly 1 in place. This configuration enables quick connection and detachment between the massage attachment 2 and the push rod assembly 1 while improving the stability and reliability of the engagement.

In some cases, the limiting member 131 may include a first protrusion 1311 and a second protrusion 1312 that are spaced apart along the axial direction of the cavity 21. Moreover, the guide groove 22 and limiting groove 23 may be formed on the outer surface of the connecting rod 13. The limiting groove 23 may include a recess 231 and an clastic protrusion 232. The elastic protrusion 232 may be disposed on a side of the recess 231 closer to the guide groove 22, and the side of the elastic protrusion 232 facing the guide groove 22 may be an inclined surface. In such cases, when connecting the massage attachment 2 to the push rod assembly 1 (e.g., after the limiting member 131 reaches the bottom of the guide groove 22 and/or when rotating the massage attachment 2 or the push rod assembly 1), the first protrusion 1311 may enter the recess 231. Further, the elastic protrusion 232 may be positioned between the first protrusion 1311 and the second protrusion 1312 to provide an elastic clamping force (e.g., stuck between the first protrusion 1311 and the second protrusion 1312). Alternatively, if both the first protrusion 1311 and second protrusion 1312 enters the recess 231, the elastic protrusion 232 may block the movement between them to secure the engagement between massage attachment 2 and push rod assembly 1. This configuration provides enhanced mechanical stability between the massage attachment 2 and the push rod assembly 1, while facilitating rapid attachment and removal.

As described herein, the cavity 21 may be configured with any number of limiting members 131 to facilitate engagement with the push rod assembly 1. For example, cavity 21 may include a single limiting member 131, or more than one limiting member 131 (e.g., two or more). The limiting members 131 may be equally spaced apart along the axial direction or arranged at unequal intervals, depending on design preferences or structural requirements. Moreover, the connecting rod 13 of the push rod assembly I may also be configured with any number of guide grooves 22 and limiting grooves 23 that are positioned to match with or dimensioned to fit the number of limiting member 131 of the cavity 21. For example, the connecting rod 13 may include a single guide groove 22 and limiting groove 23, or more than one guide groove 22 and limiting groove 23 (e.g., three or more each). The guide grooves 22 and limiting grooves 23 may also be equally or unequally spaced around the surface of the connecting rod 13, depending on design preferences or structural requirements. Such configurations provides greater flexibility for aligning the push rod assembly 1 with the massage attachment 2 and enhances compatibility with various structural configurations. Regardless of the specific quantity or spacing of the limiting members 131 and the corresponding guide grooves 22 and limiting grooves 23, the components may be configured to ensure a secure and stable engagement while still allowing for quick connection and detachment of the massage attachment 2 and the push rod assembly 1.

In some aspects, the limiting member 131 provided on the inner wall of the cavity 21 may be configured as a wedge-shaped protrusion (not shown). In some instances, the limiting groove 23 provided on the surface of the connecting rod 13 may be a wedge-shaped groove (not shown) adapted to match with or dimensioned to fit the wedge-shaped protrusion. In examples where the limiting member 131 is configured as the wedge-shaped protrusion and the limiting groove 23 is configured to be the wedge-shaped groove, upon insertion of the connecting rod 13 into the cavity 21, the wedge-shaped protrusion enters and slides along the guide groove 22. Moreover, after reaching the terminal end of the groove, the massage attachment 2 or the push rod assembly I may be rotated to align the wedge-shaped protrusion with the wedge-shaped groove, thereby forming an interference fit and achieving secure locking of the two components.

In some instances, a plurality of convex rings (not shown) may be formed on an outer wall of the connecting rod 13 on the side away from the guide groove 22. The convex rings may form an interference fit with the inner wall of the push rod sleeve 11, thereby enhancing the stability of the sleeve connection and improving the overall integrity of the push rod assembly 1.

The above description is only a preferred embodiment of the present utility model and is not intended to limit the present utility model. Any modification, equivalent substitution or improvement made within the spirit and principle of the present utility model shall be included in the protection scope of the present utility model.

Illustrative examples of the disclosure include:
Aspect 1. A connection structure between a massage attachment and a fascia gun, comprising a push rod assembly and a massage attachment, characterized in that: the push rod assembly comprises a push rod sleeve, soft rubber for connecting rod and a connecting rod, the push rod sleeve, the soft rubber for connecting rod and the connecting rod are sequentially connected in a sleeving manner, the soft rubber for connecting rod sleeves the connecting rod, the push rod sleeve sleeves the soft rubber for connecting rod, a limiting member is provided on one end of the connecting rod, the massage attachment is provided with a cavity, on an inner wall of the cavity provided are a guide groove and a limiting groove that can match with the limiting member, when connecting the massage attachment to the push rod assembly, by inserting the push rod assembly into the cavity, the limiting member enters the guide groove, and when the limiting member reaches the bottom of the guide groove, by rotating the massage attachment or the push rod assembly, the limiting member enters the limiting groove to lock the massage attachment and the push rod assembly in place.
Aspect 2. The connection structure between a massage attachment and a fascia gun of Aspect 1, characterized in that: an annular protrusion is provided on the soft rubber for connecting rod, and when connecting the massage attachment to the push rod assembly, after the limiting member enters the guide groove, the annular protrusion is squeezed by the massage attachment and the push rod sleeve to undergo elastic deformation, and the elastic force generated by the elastic deformation leads to a tendency for the massage attachment and the push rod assembly to separate from each other, thereby causing the limiting member and the limiting groove to press against each other along an axial direction of the connecting rod to further lock the massage attachment and the push rod assembly in place.
Aspect 3. The connection structure between a massage attachment and a fascia gun of Aspect 2, characterized in that: an annular flange is provided on a side of the annular protrusion close to the limiting member.
Aspect 4. The connection structure between a massage attachment and a fascia gun of any of Aspects 1-3, characterized in that: the limiting groove comprises a recess and an clastic protrusion, the elastic protrusion is arranged on a side of the recess close to the guide groove, a side of the elastic protrusion close to the guide groove is an inclined surface, the limiting member comprises a first protrusion and a second protrusion that are spaced apart and arranged along an axial direction of the connecting rod, when connecting the massage attachment to the push rod assembly, after the limiting member reaches the bottom of the guide groove, by rotating the massage attachment or the push rod assembly, the first protrusion enters the recess, and the elastic protrusion is stuck between the first protrusion and the second protrusion to secure the massage attachment and the push rod assembly, or both the first protrusion and the second protrusion enter the recess, and the elastic protrusion blocks the first protrusion and the second protrusion in the recess to secure the massage attachment and the push rod assembly.
Aspect 5. The connection structure between a massage attachment and a fascia gun of any of Aspects 1-4, characterized in that: the limiting member is a wedge-shaped protrusion, and the limiting groove is a wedge-shaped groove that can match with the wedge-shaped protrusion, when connecting the massage attachment to the push rod assembly, after the limiting member reaches the bottom of the guide groove, by rotating the massage attachment or the push rod assembly, the wedge-shaped protrusion and the wedge-shaped groove move toward each other, after the wedge-shaped protrusion and the wedge-shaped groove move toward each other to a certain position, an interference fit is formed between the wedge-shaped protrusion and the wedge-shaped groove, thereby locking the massage attachment and the push rod assembly in place.
Aspect 6. The connection structure between a massage attachment and a fascia gun of any of Aspects 1-5, characterized in that: an elastic arm hook is provided at one end of the connecting rod away from the limiting member, and a groove that can match with the elastic arm hook is provided in an inner wall of the push rod sleeve.
Aspect 7. The connection structure between a massage attachment and a fascia gun of any of Aspects 1-6, characterized in that: a plurality of convex rings are provided on an outer wall of the connecting rod on the side away from the limiting member.
Aspect 8. The connection structure between a massage attachment and a fascia gun of any one of Aspect 1-7, characterized in that: a DC power male terminal component is fixedly provided in an inner cavity of the connecting rod, and a DC power female terminal component is fixedly provided in the cavity of the massage attachment.

What is claimed is:

1. A connection structure between a massage attachment and a fascia gun, comprising:
a push rod assembly comprising:
a push rod sleeve,
a connecting rod,
soft rubber for connecting rod,
a limiting member provided on a first end of the connecting rod,
wherein, the push rod sleeve, the soft rubber for connecting rod and the connecting rod are sequentially connected in a sleeving manner, the soft rubber for connecting rod sleeves the connecting rod, and the push rod sleeve sleeves the soft rubber for connecting rod; and
a massage attachment, the massage attachment is provided with a cavity, and on an inner wall of the cavity comprises a guide groove and a limiting groove that are each dimensioned to fit the limiting member,
wherein the massage attachment is connected to the push rod assembly by inserting the push rod assembly into the cavity with the limiting member entering the guide groove from a first portion of the guide groove to a second portion of the guide groove, and rotating the massage attachment or the push rod assembly when the limiting member reaches the second portion of the guide groove causing the limiting member to enter the limiting groove from the second portion of the guide groove.

2. The connection structure between the massage attachment and the fascia gun of claim 1, wherein, the soft rubber includes an annular protrusion;
wherein when the massage attachment and the push rod assembly are connected, the annular protrusion is elastically deformed by the massage attachment and the push rod sleeve, and an elastic force generated by the elastically deformed annular protrusion causes the massage attachment and the push rod assembly to separate from each other causing the limiting member and the limiting groove to press against each other along an axial direction of the connecting rod.

3. The connection structure between the massage attachment and the fascia gun of claim 2, wherein an annular flange is provided on a side of the annular protrusion close to the limiting member.

4. The connection structure between the massage attachment and the fascia gun of claim 1, wherein the second portion of the guide groove is coupled to a first portion of the limiting groove;
wherein the limiting groove comprises a recess on a second portion of the limiting groove and an elastic protrusion on the first portion of the limiting groove, a portion of the elastic protrusion close to the second portion of the guide groove is an inclined surface;
wherein the limiting member comprises a first protrusion and a second protrusion that are spaced apart and arranged along an axial direction of the connecting rod.

5. The connection structure between the massage attachment and the fascia gun of claim 4, wherein when connecting the massage attachment to the push rod assembly and the massage attachment or the push rod assembly is being rotated, the first protrusion enters the recess towards the second portion of the limiting groove, and the elastic protrusion is positioned between the first protrusion and the second protrusion to secure the massage attachment and the push rod assembly.

6. The connection structure between the massage attachment and the fascia gun of claim 4, wherein when connecting the massage attachment to the push rod assembly and the push rod assembly or the massage attachment is being rotated, the first protrusion and the second protrusion enter the recess, and the elastic protrusion engages with at least the second protrusion in the recess to secure the massage attachment and the push rod assembly.

7. The connection structure between the massage attachment and the fascia gun of claim 1, wherein the limiting member is a wedge-shaped protrusion, and the limiting groove is a wedge-shaped groove dimensioned to fit the wedge-shaped protrusion;
wherein when connecting the massage attachment to the push rod assembly and the push rod assembly or the massage attachment is being rotated, the wedge-shaped protrusion enters a first portion of the wedge-shaped groove towards a second portion of the wedge-shaped groove to a position within the wedge-shaped groove forming an interference fit between the wedge-shaped protrusion and the wedge-shaped groove.

8. The connection structure between the massage attachment and the fascia gun of claim 1, wherein the connecting rod further comprises:
an elastic arm hook provided at a second end of the connecting rod, and
a groove dimensioned to fit the elastic arm hook, the groove being provided in an inner wall of the push rod sleeve.

9. The connection structure between the massage attachment and the fascia gun of claim 1, wherein the connecting rod further comprises a plurality of convex rings, the plurality of convex rings being provided on an outer wall of the connecting rod on a portion of the connecting rod away from a portion of the connecting rod with the limiting member.

10. The connection structure between the massage attachment and the fascia gun of claim 1 wherein an inner cavity of the connecting rod further comprises a DC power male terminal component, and the cavity of the massage attachment further comprises a DC power female terminal component.

11. A connection structure between a massage attachment and a fascia gun, comprising:
a massage attachment, the massage attachment is provided with a cavity, and on an inner wall of the cavity comprises at least one limiting member; and
a push rod assembly comprising:
a push rod sleeve,
a connecting rod,
soft rubber for connecting rod,
at least one guide groove and at least one limiting groove on a surface of the connecting rod, the at least one guide groove and the at least one limiting groove are each dimensioned to fit the at least one limiting member,
wherein, the push rod sleeve, the soft rubber for connecting rod and the connecting rod are sequentially connected in a sleeving manner, the soft rubber for connecting rod sleeves the connecting rod, and the push rod sleeve sleeves the soft rubber for connecting rod,
wherein the massage attachment is connected to the push rod assembly by inserting the push rod assembly into the cavity with the at least one limiting member entering the at least one guide groove from a first portion of the at least one guide groove to a second portion of the at least one guide groove, and rotating the push rod assembly or massage attachment when the at least one limiting member reaches the second portion of the at least one guide groove causing the at least one limiting member to enter the at least one limiting groove from the second portion of the at least one guide groove.

12. The connection structure between the massage attachment and the fascia gun of claim 11, wherein, the soft rubber includes an annular protrusion;
wherein when the massage attachment and the push rod assembly are connected, the annular protrusion is elastically deformed by the massage attachment and the push rod sleeve, and an elastic force generated by the elastically deformed annular protrusion causes the massage attachment and the push rod assembly to separate from each other causing the at least one limiting member and the limiting groove to press against each other along an axial direction of the connecting rod.

13. The connection structure between the massage attachment and the fascia gun of claim 12, wherein an annular flange is provided on a side of the annular protrusion close to the at least one limiting member.

14. The connection structure between the massage attachment and the fascia gun of claim 11, wherein the second portion of the at least one guide groove is coupled to a first portion of the at least one limiting groove;
wherein the limiting groove comprises a recess on a second portion of the limiting groove and an elastic protrusion on the first portion of the limiting groove, a portion of the elastic protrusion close to the second portion of the at least one guide groove is an inclined surface;
wherein the at least one limiting member comprises a first protrusion and a second protrusion that are spaced apart and arranged along an axial direction of the connecting rod.

15. The connection structure between the massage attachment and the fascia gun of claim 14, wherein when connecting the massage attachment to the push rod assembly and the push rod assembly or the massage attachment is being rotated, the first protrusion enters the recess towards the second portion of the limiting groove, and the elastic protrusion is positioned between the first protrusion and the second protrusion to secure the massage attachment and the push rod assembly.

16. The connection structure between the massage attachment and the fascia gun of claim 14, wherein when connecting the massage attachment to the push rod assembly and the push rod assembly or the massage attachment is being rotated, the first protrusion and the second protrusion enter the recess, and the elastic protrusion engages with at least the second protrusion in the recess to secure the massage attachment and the push rod assembly.

17. The connection structure between the massage attachment and the fascia gun of claim 11, wherein the at least one limiting member is a wedge-shaped protrusion, and the at least one limiting groove is a wedge-shaped groove dimensioned to fit the wedge-shaped protrusion;
wherein when connecting the massage attachment to the push rod assembly and the push rod assembly or the massage attachment is being rotated, the wedge-shaped protrusion enters a first portion of the wedge-shaped groove towards a second portion of the wedge-shaped groove to a position within the wedge-shaped groove forming an interference fit between the wedge-shaped protrusion and the wedge-shaped groove.

18. The connection structure between the massage attachment and the fascia gun of claim 11, wherein the connecting rod further comprises:
an elastic arm hook provided at a second end of the connecting rod, and
a groove dimensioned to fit the elastic arm hook, the groove being provided in an inner wall of the push rod sleeve.

19. The connection structure between the massage attachment and the fascia gun of claim 11, wherein the connecting rod further comprises a plurality of convex rings, the plurality of convex rings being provided on an outer wall of the connecting rod on a portion of the connecting rod away from a portion of the connecting rod with the at least one limiting member.

20. The connection structure between the massage attachment and the fascia gun of claim 11 wherein an inner cavity of the connecting rod further comprises a DC power male terminal component, and the cavity of the massage attachment further comprises a DC power female terminal component.
